(19) United States
(12) Patent Application Publication
(10) Pub. No.: US 2016/0292646 A1
(43) Pub. Date: Oct. 6, 2016

(54) LABOR ASSET INFORMATION MANAGEMENT APPARATUS AND METHOD, AND COMPUTER PROGRAM

(71) Applicant: Yoshikazu TAKASAKI, Tokyo (JP)

(72) Inventor: Yoshikazu TAKASAKI, Tokyo (JP)

(73) Assignee: Masahiro TAKASAKI, Tokyo (JP)

(21) Appl. No.: 14/964,594

(22) Filed: Dec. 10, 2015

(30) Foreign Application Priority Data
Dec. 10, 2014 (JP) 2014-250174

(51) Int. Cl. G06Q 10/10; H04L 29/06

(52) U.S. Cl. CPC G06Q 10/1057; H04L 63/10; H04L 63/08

(57) ABSTRACT

A labor asset information management apparatus includes a personnel/labor information DB that stores personnel/labor information, a labor asset information DB that stores labor asset information, and an association information DB that stores association information between the personnel/labor information and the labor asset information. A registration processing unit registers the labor asset information into the personnel/labor information DB as information constructing the personnel/labor information with which the labor asset information is associated according to the association information, an update processing unit refers to the personnel/labor information DB or the labor asset information DB to update and register update information of the personnel/labor information or the labor asset information, and a reflection processing unit reflects an update on one of the personnel/labor information and the labor asset information in another one of the labor asset information and the personnel/labor information associated with each other by referring to the association information DB.

### CROSS-REFERENCE

This application claims priority to JP2014-250174 filed on Dec. 10, 2014, which is incorporated herein by reference.

### FIELD OF THE INVENTION

The present invention relates to a technology in which, among personnel/labor information on human resources, attendance, salary, and labor managed by a company, labor asset information pertaining to information on an individual worker is separated from the other information and managed by a third party so that the labor asset information is utilized to improve life of the individual worker.

### BACKGROUND OF THE INVENTION

A company manages information on human resources, salary, bonus, and attendance of a worker in order to abide by a data retention obligation according to laws and regulations and to pay wages. Information obliged by the laws and regulations such as a roster, a payroll, a salary statement, a tax and dues sheet, a year-end adjustment sheet, and raise/promotion is only sent to a worker in print or by e-mail and cannot be utilized in any way other than managed and retained by the worker at his own will. Even when utilized, the information that can be freely manipulated or altered cannot be trusted in an objective way and thus has not been utilized effectively. The company erases and eliminates accumulated information once a retention period established by the laws and regulations passes, and does not hand over data to a person who has resigned or changed jobs.

Such important information on labor assets of the worker cannot be handled freely by the worker nor utilized. This means that the worker cannot prove in what type of industry and operation he worked in the past as well as what kind of work and task he has experienced spending how much time thereon.

While an airplane pilot is evaluated by flight hours, for example, this does not apply to a general worker. Moreover, a non-permanent worker wishing to step up to a permanent worker or a worker changing jobs honestly wishes to make his past career/experience and strength known. For example, a record on good morale that he is never late to work and has perfect attendance, time spent in training, an achievement of acquiring a qualification and effort made therefor, an evaluation by his boss, coworker and subordinate, a history of getting a medical examination, the number of hours and rate of overtime work, and a record showing how much he spent on work such as the number and rate of days off and vacations acquired are all assets of the worker. A system that allows a third party to prove the labor assets of the worker leads to supporting the worker working diligently.

Currently, the labor asset information is not utilized in re-employment where there is no choice but to use a self-reported resume. Moreover, when utilized effectively, the labor asset information confirmed by the third party can also be used in opening a bank account as well as signing up and applying for credit cards and various insurances. The labor asset information also provides an objective evaluation for loan application and can be used in reviewing and determining qualification for credit. Moreover, provision of the labor asset information in detail leads to a merit on the worker's side in terms of premium setting, discount and reduction as well as allows one to propose detailed conditions for each worker.

In this respect, JP 2003-187077 A proposes a financing method employed by a financial institution which performs lending with a credit line set by determining the ability to repay on the basis of personal information of a loan applicant who receives salary as an employee from his employer, where the financing method includes a step of successively registering attendance information on the attendance of the loan applicant from his employer through a communication network, a step of calculating the amount of salary at the time when financing is requested by the loan applicant on the basis of the attendance information and salary information of the loan applicant, a step of acquiring the calculated amount of salary through the communication network, and a step of determining a credit line for the loan applicant on the basis of the amount of salary.

Moreover, JP 2009-075925 A proposes a payroll management server including: a worker information database which is connected to a cash dispenser through a communication unit and manages information on a worker; a company information database which manages information on a company in which the worker takes part; a cash dispenser input information reception unit which receives worker information input through the cash dispenser to identify the worker as well as a requested withdrawal amount; a withdrawal amount information transmission unit which transmits, to the cash dispenser, a piece of withdrawal amount information used to withdraw a predetermined amount of money; an amount comparison unit which reads remaining salary information on the salary not yet withdrawn from the worker information database by using the worker information received from the cash dispenser input information reception unit and compares the remaining salary and the requested withdrawal amount; and a withdrawal amount determination unit which determines the request withdrawal amount as the withdrawal amount information when the amount comparison unit determines that the requested withdrawal amount equals the remaining salary or lower and then transfers the information to the withdrawal amount information transmission unit, where the payroll management server further includes a credit determination unit which determines credit of the worker so that, when the amount comparison unit determines that the requested withdrawal amount is higher than the remaining salary, the credit determination unit determines the credit of the worker, and the withdrawal amount determination unit adds a difference between the requested withdrawal amount and the remaining salary to the remaining salary within the range of an available credit set by the credit determination unit, determines the amount as the withdrawal amount information, and transfers the information to the withdrawal amount information transmission unit.

### SUMMARY OF THE INVENTION

However, the labor asset information unique and personal to the worker is also an important piece of information that can be used effectively when the worker leaves a specific company to move to another company or resigns from a company. Moreover, the personnel/labor information managed within the company includes a considerable amount of information, such as organization information and project information, requiring strict management or confidential information separately from the labor asset information, where leakage of these information need be certainly prevented.

Accordingly, an object of the present invention is to provide a system which separates the labor asset information unique to the worker in the personnel/labor information managed within the company from the other information such as the confidential information of the company, individually extracts and separately manages the labor asset information unique to the worker, and allows the worker to utilize his own labor asset information for himself or allows the company to have a reduced load of dealing with human resources and labor.

In order to achieve the aforementioned object, a labor asset information management apparatus according to one aspect of the present invention is an apparatus that separately manages labor asset information unique to a worker among information constructing personnel/labor information related to human resources and labor of a worker, the apparatus comprising: a personnel/labor information storage unit that stores the personnel/labor information; a labor asset information storage unit that stores the labor asset information; a setting processing unit that sets association between the personnel/labor information and the labor asset information; an association information storage unit that stores association information between the personnel/labor information and the labor asset information; a registration processing unit that registers, into the personnel/labor information storage unit, the labor asset information as information constructing the personnel/labor information with which the labor asset information is associated; an update processing unit that updates and registers update information on the personnel/labor information or the labor asset information by referring to the personnel/labor information storage unit or the labor asset information storage unit; and a reflection processing unit that reflects an update of one of the personnel/labor information and the labor asset information in another one of the labor asset information and the personnel/labor information associated with each other by referring to the association information storage unit.

Moreover, the labor asset information management apparatus may also be configured to be able to communicate with a worker terminal used by the worker through a network and further include an authentication processing unit that authenticates an access to the labor asset information storage unit storing the labor asset information from the worker terminal, on the basis of unique authentication information issued to a worker holding the labor asset information.

Moreover, the labor asset information management apparatus may further include an edit accepting unit that accepts, from the worker terminal, an edit on the labor asset information stored in the labor asset information storage unit.

It may also be adapted such that editing of predetermined information by the worker is restricted, the predetermined information being included in the labor asset information stored in the labor asset information storage unit.

Moreover, the labor asset information management apparatus may further include a history recording unit that records a history of an edit performed by the worker on the labor asset information stored in the labor asset information storage unit.

Moreover, the labor asset information management apparatus may further include: a review/contract information storage unit that stores review criteria corresponding to the labor asset information for a contract-requiring product; a review processing unit that, on the basis of an application for a predetermined contract-requiring product by the worker, performs a review pertaining to whether or not the predetermined contract-requiring product can be provided by referring to the labor asset information and the review/contract information storage unit; and a contract approval reception unit that receives from the worker terminal a contract approval based on a result of the review with regard to the predetermined contract-requiring product, wherein the update processing unit may be configured to refer to the labor asset information storage unit to update and register information on the contract-requiring product, a contract of which is completed by the contract approval, as a piece of information constructing the labor asset information.

Here, the contract-requiring product means a product that requires a contract going through a review such as opening of a bank account, a credit card, and a loan.

It may also be adapted such that the predetermined contract-requiring product is an insurance for which a predetermined premium is determined, and the labor asset information management apparatus further includes a payroll deduction processing unit that executes processing of referring to the personnel/labor information storage unit in which information on an insurance updated and registered in the labor asset information storage unit is reflected and deducting the premium from a salary of the worker according to content of the insurance.

Moreover, a labor asset information management method according to another aspect of the present invention is a method that separately manages labor asset information unique to a worker as labor asset information among information constructing personnel/labor information related to human resources and labor of a worker, the method causing a computer to execute: processing of setting association between the personnel/labor information and the labor asset information; processing of registering, into a personnel/labor information storage unit, the labor asset information as labor asset information constructing the personnel/labor information with which the labor asset information is associated according to association information; processing of updating and registering update information on the personnel/labor information or the labor asset information by referring to the personnel/labor information storage unit or a labor asset information storage unit; and processing of reflecting an update of one of the personnel/labor information and the labor asset information in another one of the labor asset information and the personnel/labor information associated with each other by referring to an association information storage unit, the computer including: the personnel/labor information storage unit that stores the personnel/labor information; the labor asset information storage unit that stores the labor asset information; and the association information storage unit that stores the association information between the personnel/labor information and the labor asset information.

Moreover, a computer program according to yet another aspect of the present invention is a program that separately manages labor asset information unique to a worker as labor asset information among information constructing personnel/labor information related to human resources and labor of a worker, the program causing a computer to execute: processing of setting association between the personnel/labor information and the labor asset information; processing of registering, into a personnel/labor information storage unit, the labor asset information as labor asset information constructing the personnel/labor information with which the labor asset information is associated according to association information; processing of updating and registering update information on the personnel/labor information or the labor asset information by referring to the personnel/labor information storage unit or a labor asset information storage unit; and processing of reflecting an update of one of the personnel/labor information and the labor asset information in another one of the labor asset information and the personnel/labor information associated with each other by referring to an association information storage unit, the computer including: the personnel/labor information storage unit that stores the personnel/labor information; the labor asset information storage unit that stores the labor asset information; and the association information storage unit that stores the association information between the personnel/labor information and the labor asset information.

According to the present invention, the labor asset information unique to the worker in the personnel/labor information managed within the company is separated from the other information and managed separately, so that the worker can utilize the labor asset information while preventing important information within the company from being leaked out.

### BRIEF DESCRIPTION OF THE DRAWINGS

FIGS. 1A and 1B are schematic diagrams each illustrating an overview of a system that utilizes labor asset information by a labor asset information management apparatus according to a first embodiment of the present invention;

FIG. 2 is a functional block diagram illustrating a function included in the labor asset information management apparatus of the present embodiment;

FIGS. 3A-C are a table illustrating an example of data stored in a personnel/labor information DB in the labor asset information management apparatus of the present embodiment;

FIGS. 4A-H are a table illustrating an example of data stored in a labor asset information DB in the labor asset information management apparatus of the present embodiment;

FIGS. 5A-D are a table illustrating an example of data stored in an association information DB in the labor asset information management apparatus of the present embodiment;

FIG. 6 is a processing flow diagram illustrating the flow of processing performed by the labor asset information management apparatus of the present embodiment;

FIG. 7 is a sequence diagram illustrating the flow of processing performed by the labor asset information management apparatus of the present embodiment;

FIG. 8 is a sequence diagram illustrating the flow of processing performed by the labor asset information management apparatus of the present embodiment;

FIG. 9 is a sequence diagram illustrating the flow of processing performed by the labor asset information management apparatus of the present embodiment;

FIG. 10 is a functional block diagram illustrating a function included in a labor asset information management apparatus according to a second embodiment of the present invention; and

FIG. 11 is a sequence diagram illustrating the flow of processing performed by the labor asset information management apparatus of the present embodiment.

### DETAILED DESCRIPTION OF THE INVENTION

A labor asset information management apparatus according to an embodiment of the present invention will now be described with reference to the drawings.

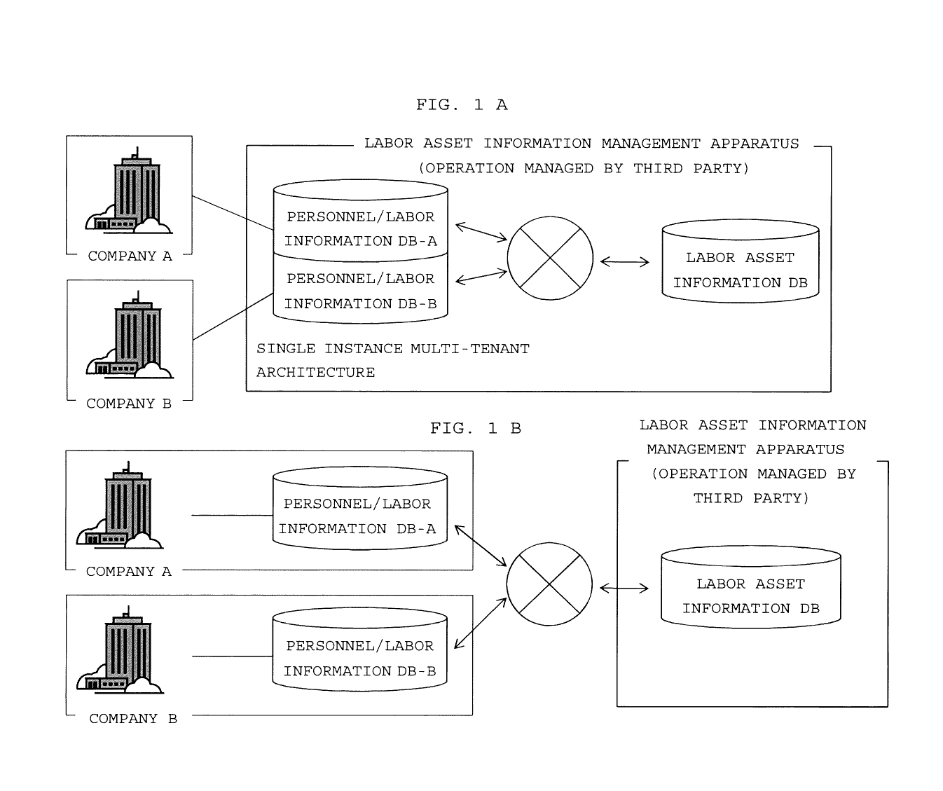

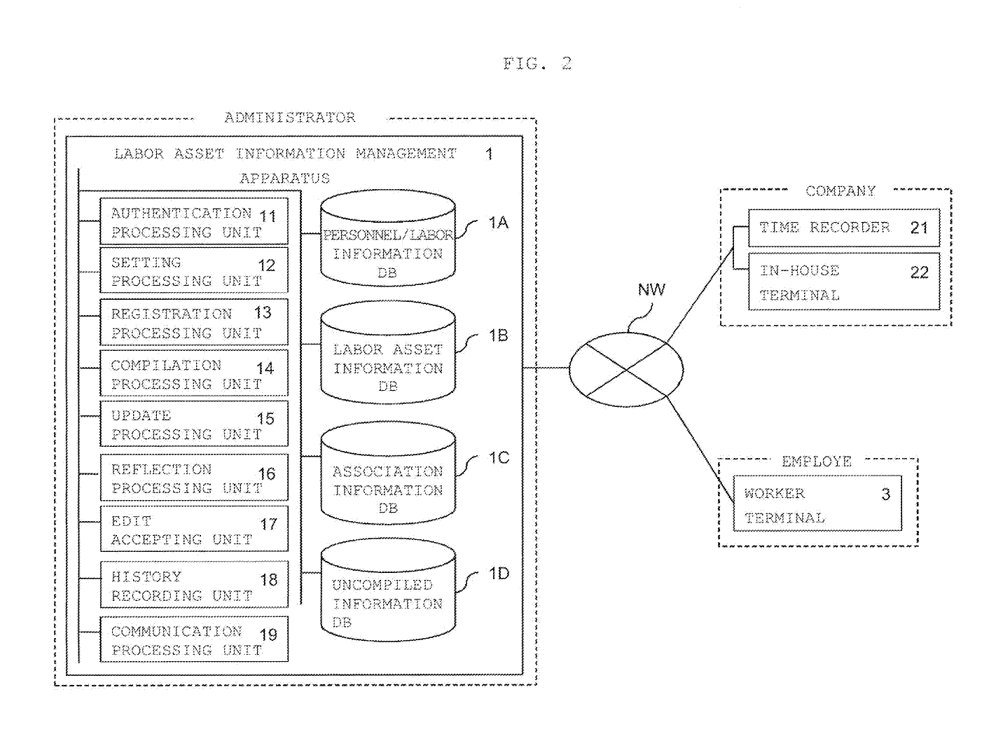

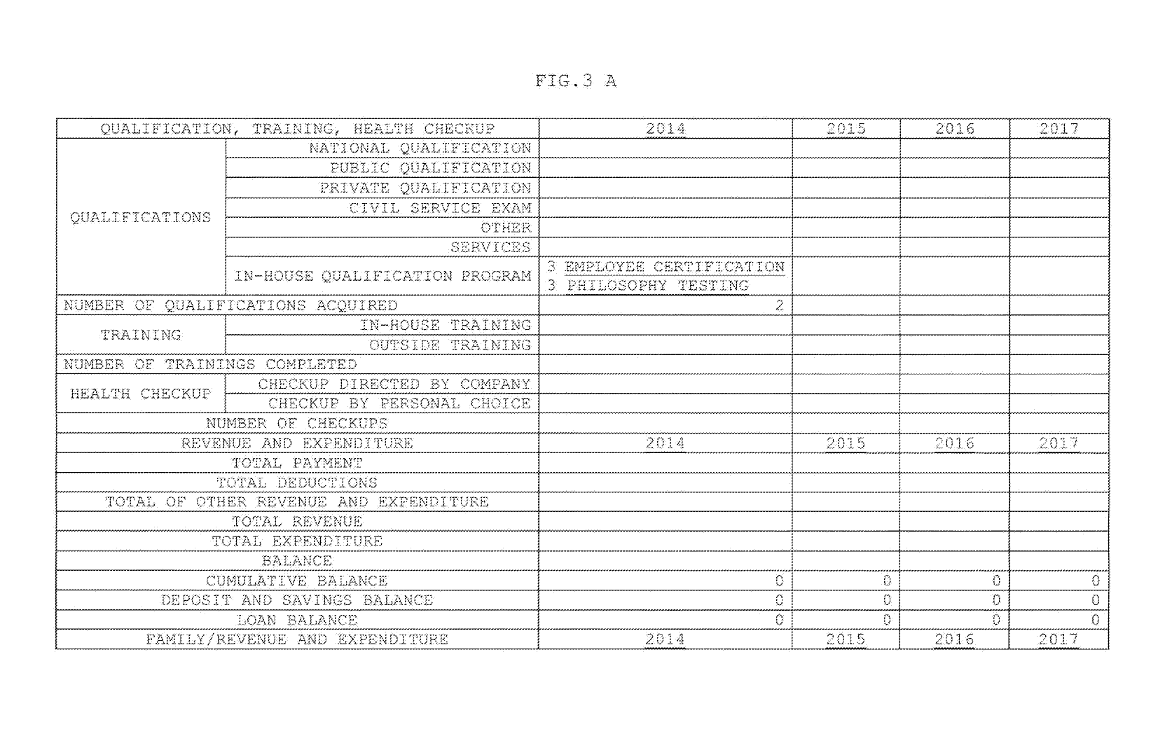

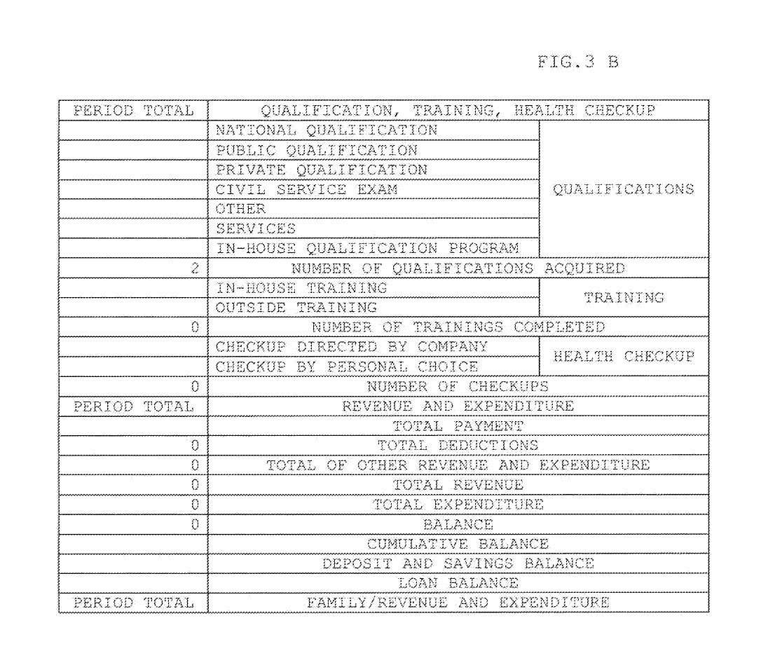

FIG. 1A will be referenced first to describe an overview of a system that utilizes labor asset information by a labor asset information management apparatus of the present embodiment.

Personnel/labor information of a company A and personnel/labor information of a company B are stored in a personnel/labor information DB-A and a personnel/labor information DB-B of a labor asset information management apparatus operated and managed by a third party, respectively. On the other hand, labor asset information unique to each worker is stored in a labor asset information DB of the labor asset information management apparatus.

Note that the embodiment of the present invention is not limited to such mode where, as illustrated in FIG. 1B, the personnel/labor information of the company A or the company B may be stored in a personnel/labor information DB-A or a personnel/labor information DB-B operated and managed by the company A or the company B so that the labor asset information management apparatus can transmit/receive data to/from the personnel/labor information DB-A or the personnel/labor information DB-B.

The labor asset information unique to a worker is included in the personnel/labor information stored in the personnel/labor information DB but is also managed in the labor asset information DB that is provided separately from the personnel/labor information DB.

When a worker A works for the company A, for example, information on the worker A is registered as a part of the personnel/labor information in the personnel/labor information DB-A and at the same time registered as the labor asset information in the labor asset information DB. As long as the worker A works for the company A, the labor asset information of the worker A registered in the personnel/labor information DB-A is basically identical to the labor asset information of the worker A registered in the labor asset information DB so that when either one of the information is updated, the update is reflected in the other information as well.

Here, when the worker A tries to change jobs from the company A to the company B, the worker A can present his own labor asset information stored in the labor asset information DB to the company B. When the worker A is actually employed by the company B, all or a part of the labor asset information of the worker A stored in the labor asset information DB is registered as a part of the personnel/labor information in the personnel/labor information DB-B of the company B.

As a result, the worker A can utilize the information accumulated when he was a worker in the company A as objective information when changing jobs, as well as the labor asset information of the worker A can be taken into the personnel/labor information DB-B of the company B as a part of the personnel/labor information and be utilized in personnel assignment and project assignment in the company B.

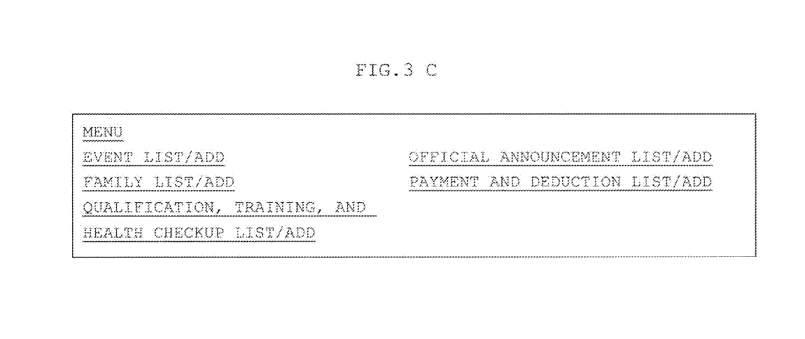

In order to realize such system, FIG. 2 illustrates a configuration of a labor asset information management apparatus 1 according to a first embodiment.

The labor asset information management apparatus 1 is configured to be able to perform communication with a time recorder 21 and an in-house terminal 22 that are installed in a company for which the worker works as well as a worker terminal 3 used by the worker through a network NW such as the Internet.

The labor asset information management apparatus 1 manages personnel/labor information related to human resources and labor of the worker as well as labor asset information included in the personnel/labor information and unique to the worker, and is managed by an administrator of a third party different from the company or a worker working therefor in the present embodiment.

The labor asset information management apparatus 1 is realized by a so-called server computer or the like and uses hardware resources including a CPU (Central Processing Unit), a RAM (Random Access Memory), a ROM (Read Only Memory) and a hard disk drive as well as a software resource including a computer program run by the CPU to configure a functional block including an authentication processing unit 11, a setting processing unit 12, a registration processing unit 13, a compilation processing unit 14, an update processing unit 15, a reflection processing unit 16, an edit accepting unit 17, a history recording unit 18, a communication processing unit 19, a personnel/labor information DB 1A, a labor asset information DB 1B, an association information DB 1C, and an uncompiled information DB 1D.

The personnel/labor information DB 1A is a storage that stores personnel/labor information related to human resources and labor of a worker for each company.

As illustrated in FIGS. 3A-C, for example, the personnel/labor information DB 1A stores the personnel/labor information such as a personnel evaluation and attendance management for each individual worker in each company. Here, the personnel/labor information includes labor asset information of each worker as a piece of information constructing the personnel/labor information.

On the other hand, the labor asset information DB 1B is a storage that stores the labor asset information unique to a worker.

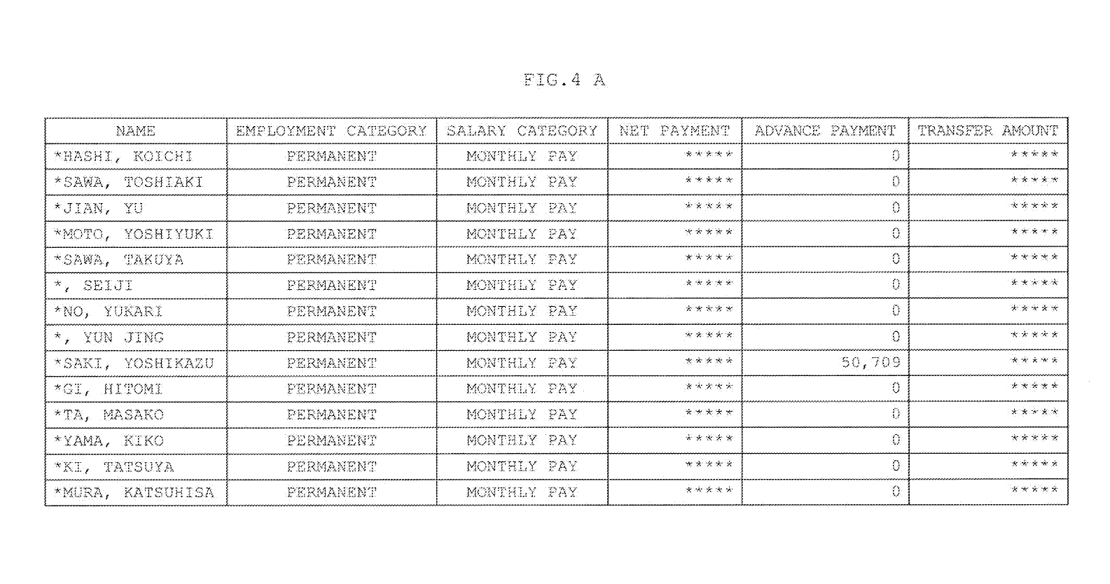

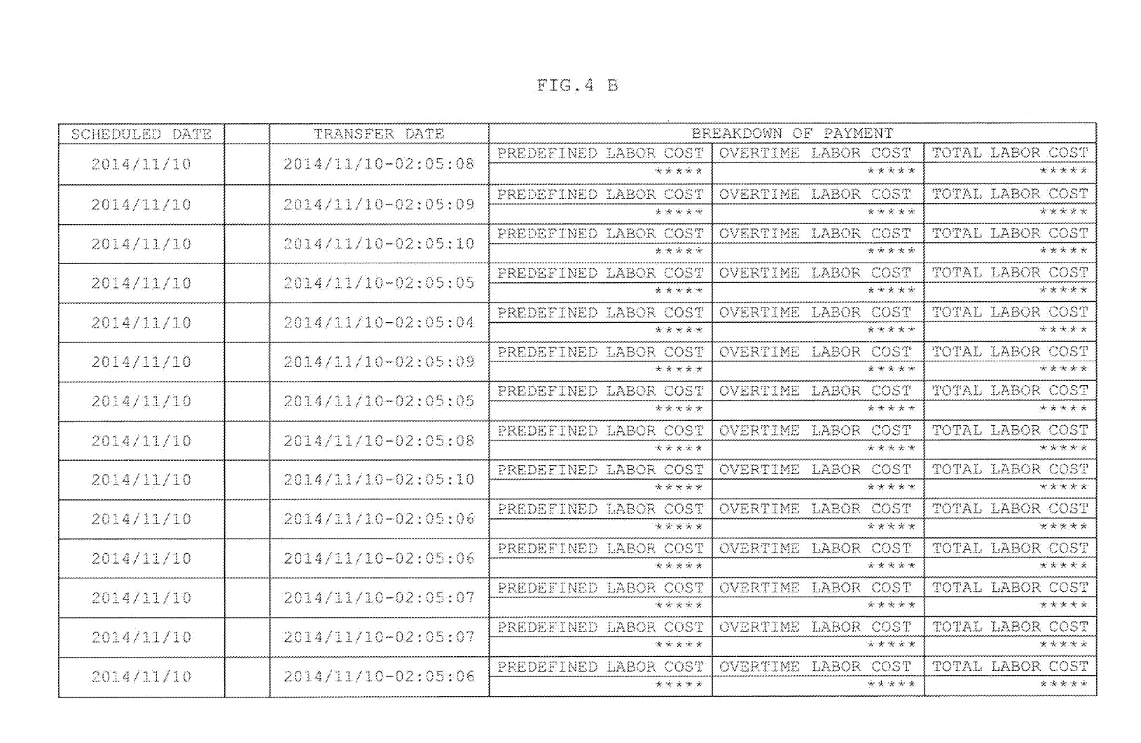

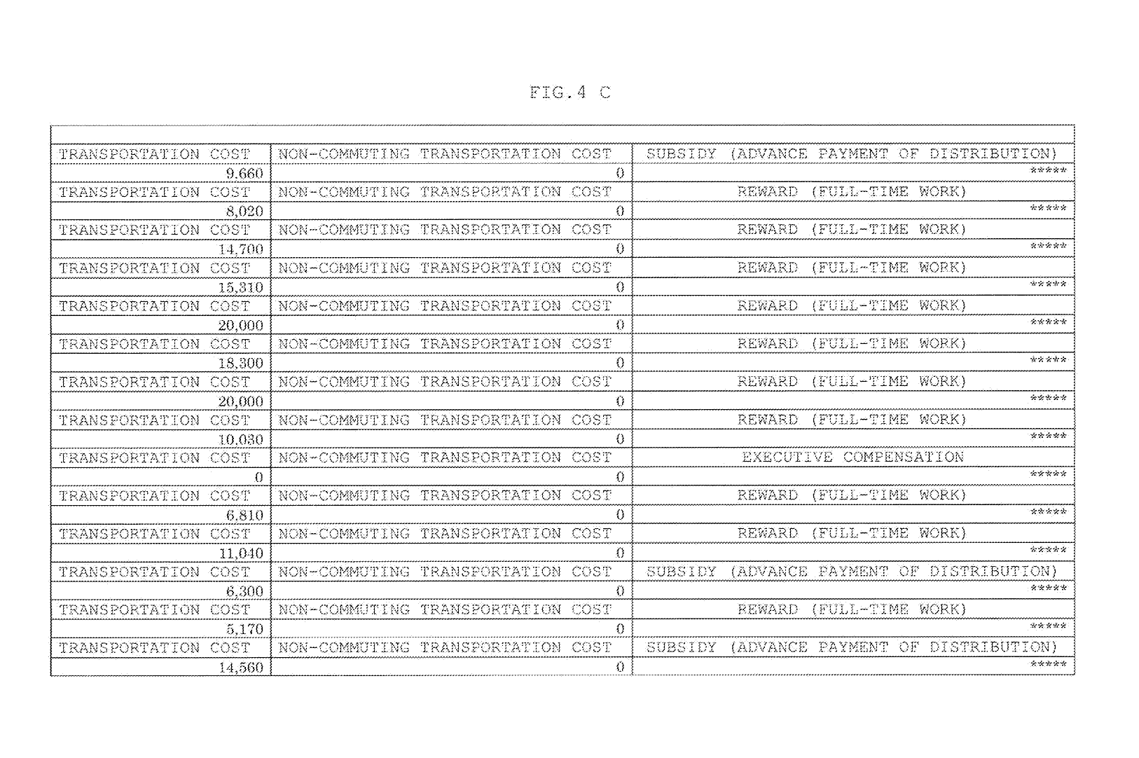

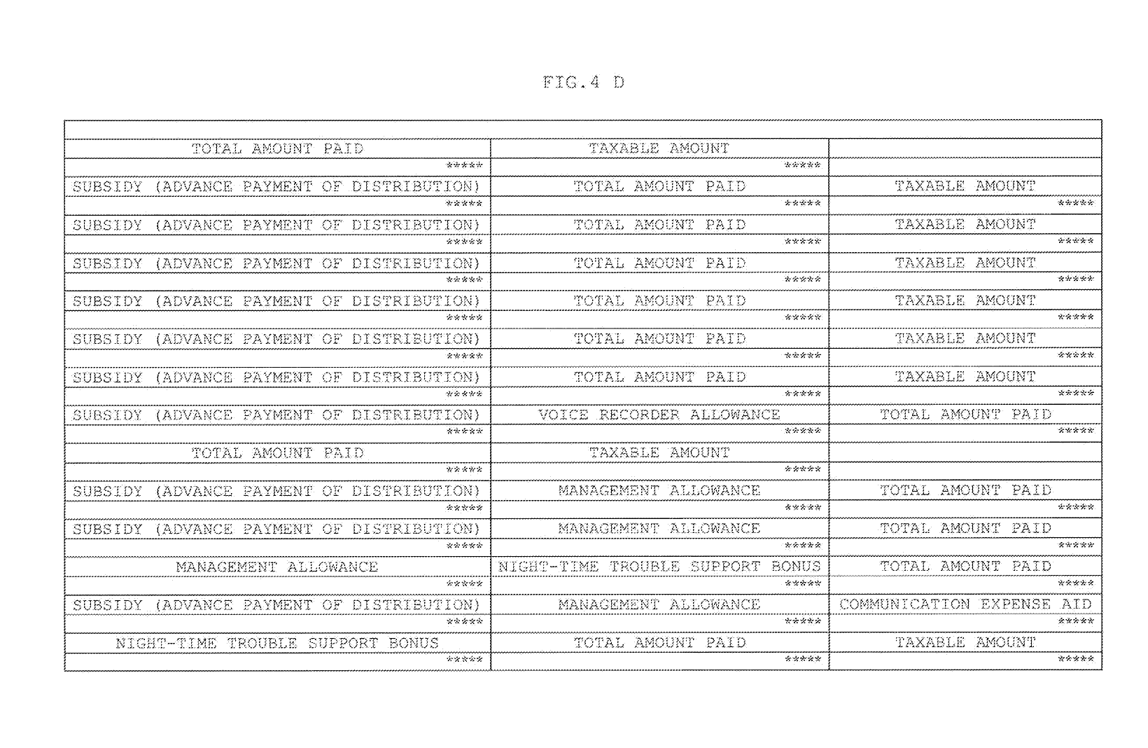

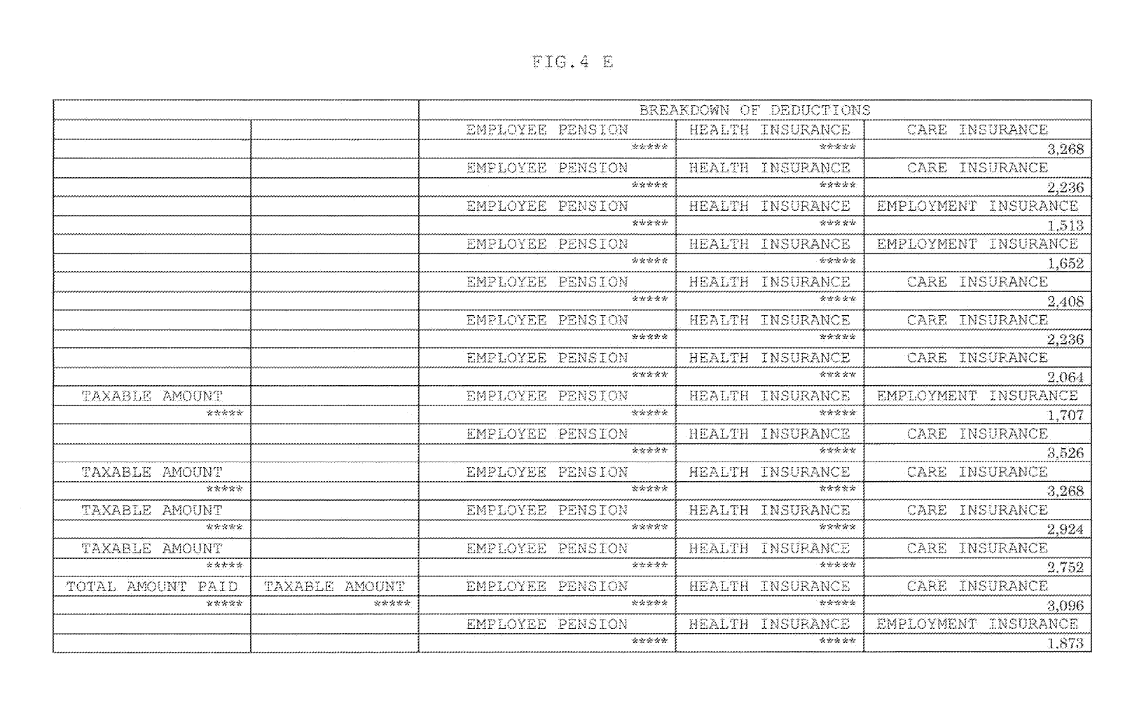

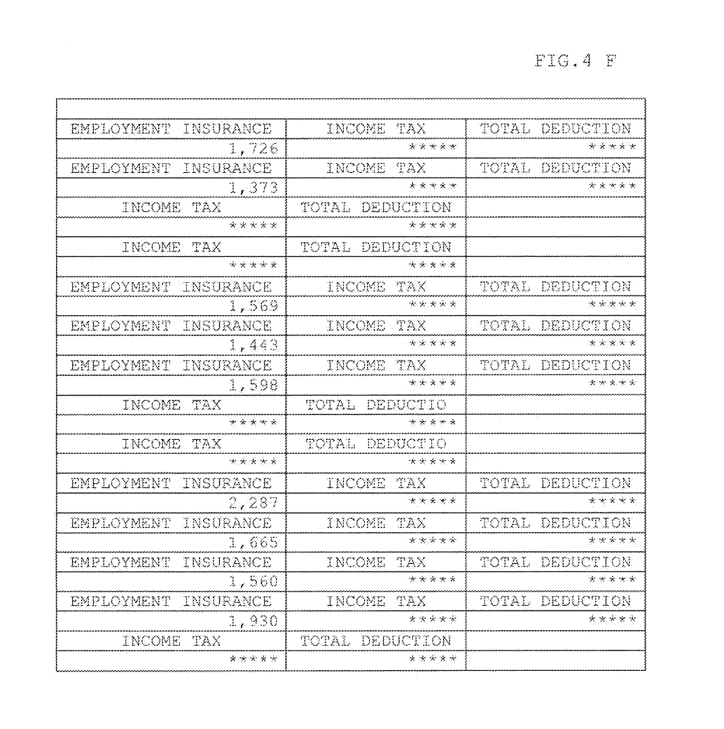

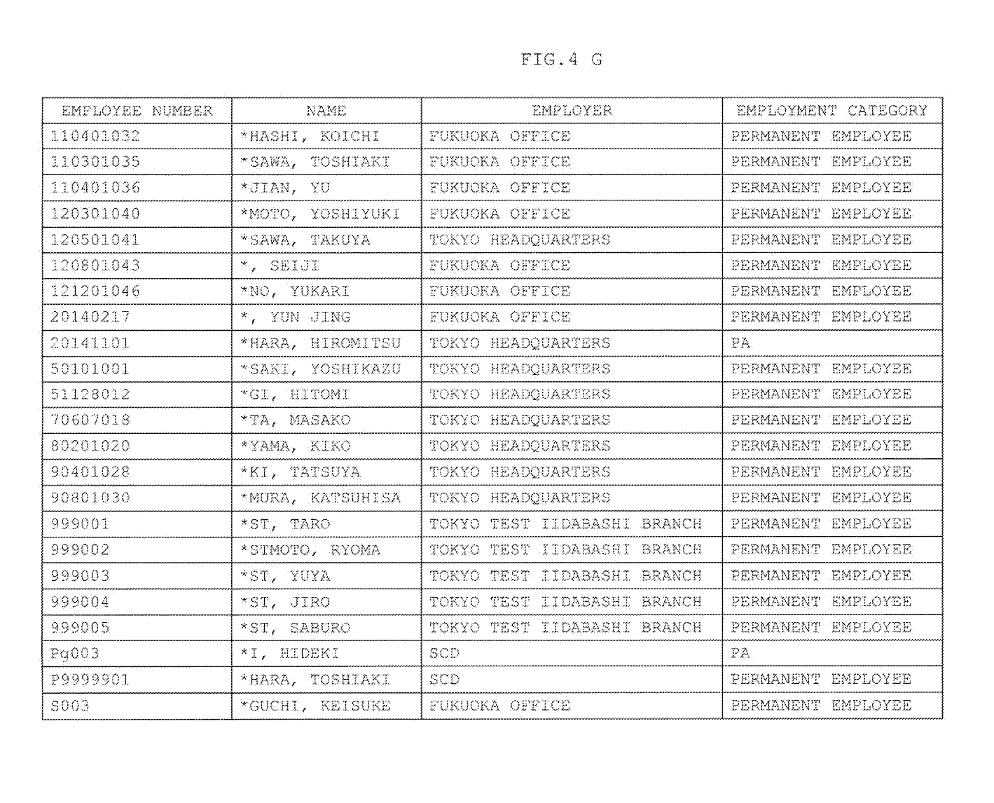

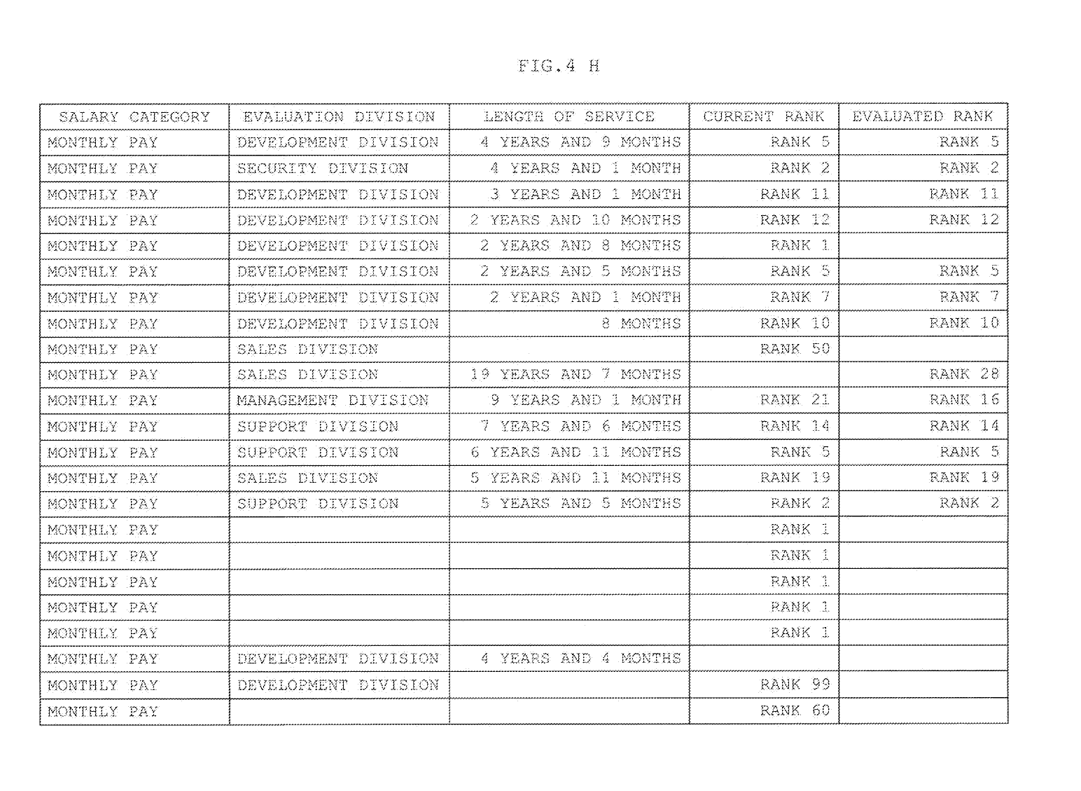

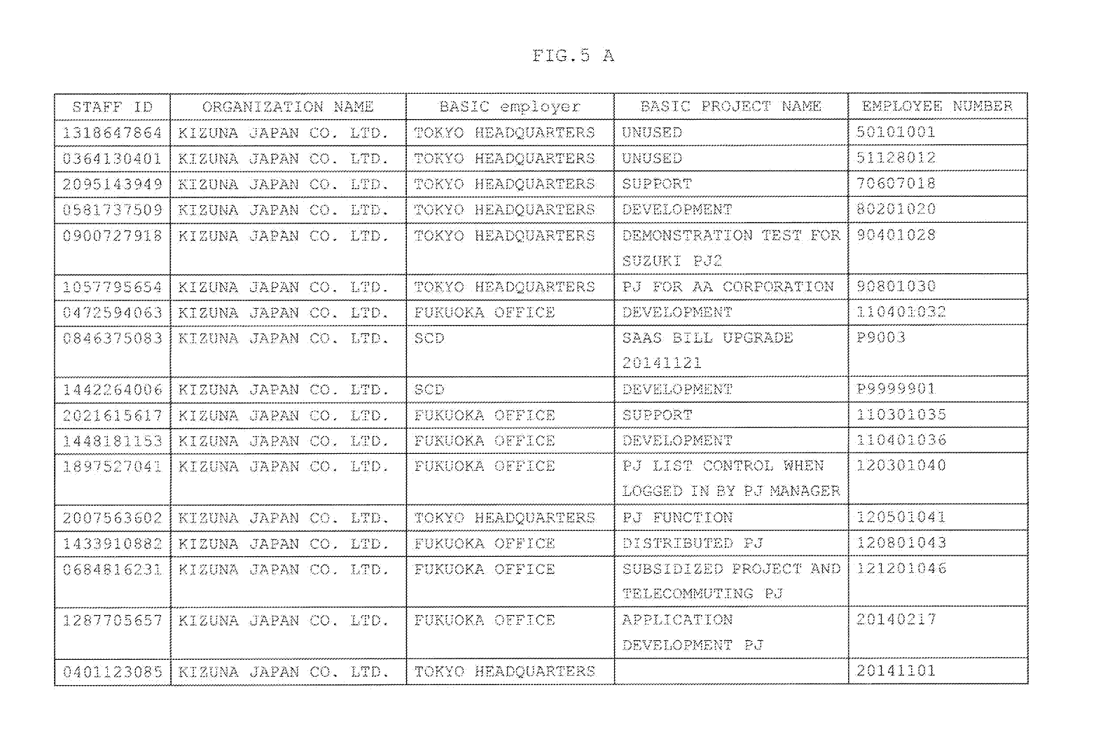

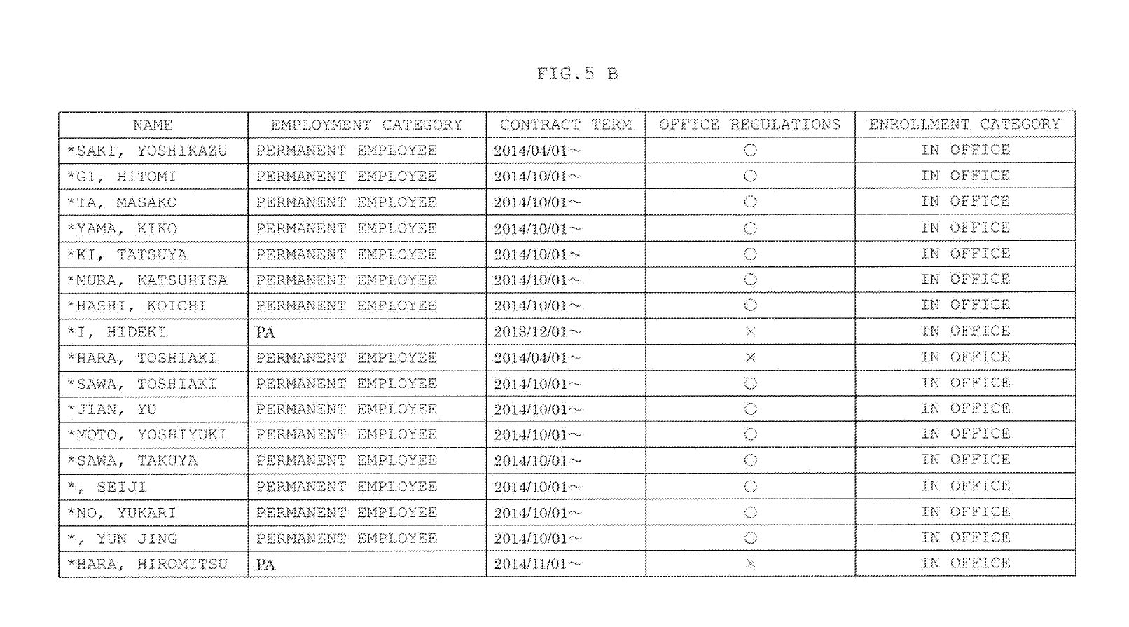

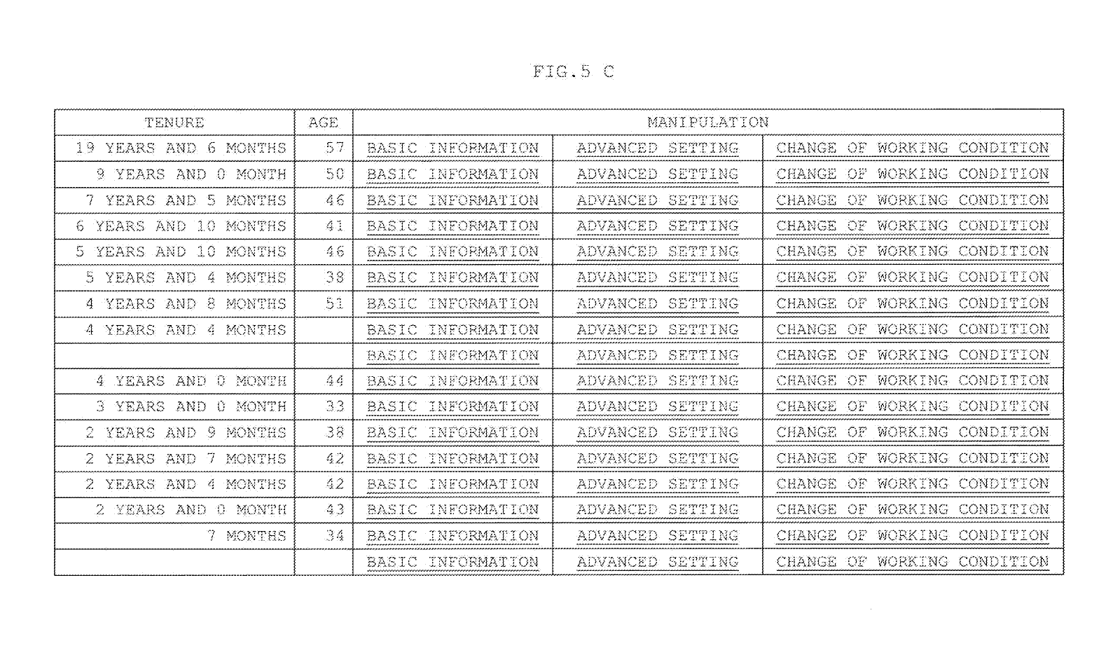

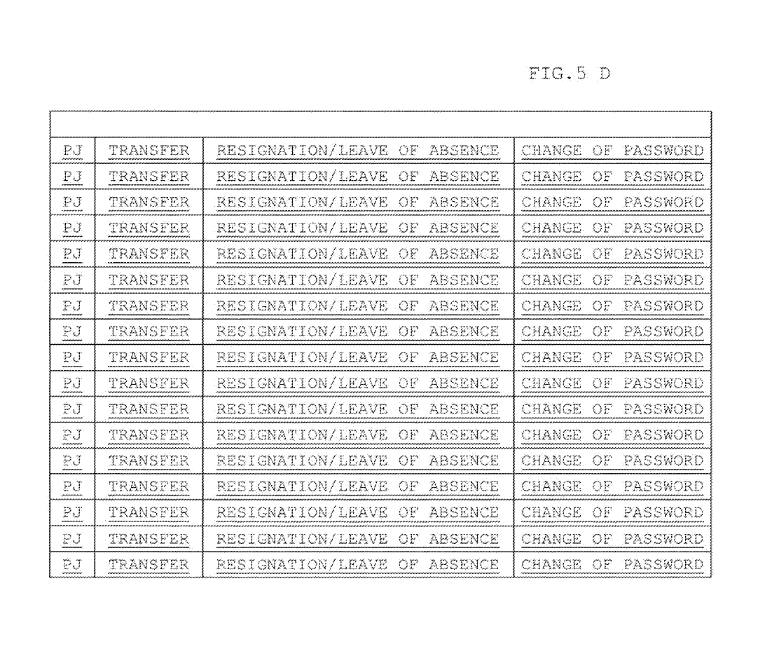

As illustrated in FIGS. 4A-H, for example, the labor asset information includes information related to an individual attribute of a worker, rank and title information, salary and benefit information, and information on public payments and deductions regarding tax and public dues, social insurance, and pension.

The labor asset information can be accessed by a worker on the basis of unique authentication information, and is adapted to be able to set in advance whether or not the worker can perform an edit for each item of the labor asset information. The labor asset information corresponding to a current situation can be provided while keeping objectivity of an evaluation on the worker by, for example, restricting an edit on an item such as a work record, a salary record, a training record, or a qualification acquisition record that is important in evaluating work performance of an individual worker but allowing one to edit only information related to personal life such as a current address, a family structure, and dependent information.

Moreover, the labor asset information is adapted such that the worker can set whether or not information in each item is to be disclosed. Note that another example may be adapted to not allow the worker to perform any edit or modification on the labor asset information.

The personnel/labor information includes the labor asset information of a worker as a piece of information constructing the personnel/labor information, where the labor asset information can be constructed by being extracted from the personnel/labor information for each worker. The labor asset information is the same information as the labor asset information stored in the labor asset information DB 1B. On the other hand, in the personnel/labor information, information other than the labor asset information stays within the personnel/labor information DB 1A and can be handled only by those having predetermined authority.

The associated information DB 1C is a storage that stores association information between the personnel/labor information and the labor asset information. When the worker A works for the company A, for example, the personnel/labor information of the company A and the labor asset information of the worker A are associated with each other so that, when one of the personnel/labor information and the labor asset information is updated requiring an update on another one of the information, the other information can be identified and updated.

The uncompiled information DB 1D is a database storing uncompiled information that is a piece of raw data such as attendance information acquired from the time recorder 21 and is not yet compiled by the compilation processing unit 14.

Normally, the raw data acquired from the time recorder 21 does not construct the personnel/labor information as it is but becomes definite personnel/labor information only after the compilation processing is performed according to a predetermined work rule or accounting operation or after the lapse of a period required for compilation. In this example, the attendance information acquired from the time recorder 21 and raw data among data input from the in-house terminal 22 are temporarily stored in the uncompiled information DB 1D and complied by the compilation processing unit 14, so that the information after undergoing the compilation processing is registered as the personnel/labor information into the personnel/labor information DB 1A.

The authentication processing unit 11 authenticates authority of a person who accesses information registered in the database. In the present embodiment, a worker is granted access to only his own labor asset information stored in the labor asset information DB 1B by using an authentication ID and a password issued in advance.

The personnel/labor information stored in the personnel/labor information DB 1A can be accessed from the in-house terminal 22 or the worker terminal 3 by a person having predetermined authority within the company with use of an authentication ID and a password issued in advance.

The setting processing unit 12 executes processing of setting association between the personnel/labor information and the labor asset information by referring to the association information DB 1C. When the worker A having been employed by the company A is newly employed by the company B, for example, the labor asset information of the worker A stored in the labor asset information DB 1B is associated with the personnel/labor information of the company B once the labor asset information of the worker A is provided to the company B at will of the worker A. In response to the association, the labor asset information of the worker A is taken into the company B's personnel/labor information as a part thereof.

The registration processing unit 13 registers the labor asset information, which is included in the personnel/labor information and includes information unique to a worker, into the labor asset information DB 1B or into the personnel/labor information DB 1A as a part of the personnel/labor information on the basis of the association information stored in the association information DB 1C.

The compilation processing unit 14 executes processing that makes the uncompiled information accumulated in the uncompiled information DB 1D into the definite personnel/labor information according to a predetermined work rule or accounting operation or after a predetermined period required for compilation. As for the working hours of a worker acquired by the time recorder 21, for example, one waits until the end of the month according to specified working hours per month and then calculates overtime hours as hours exceeding the specified working hours.

The update processing unit 15 refers to the personnel/labor information DB 1A or the labor asset information DB 1B and updates/registers update information of the personnel/labor information or the labor asset information. The update processing unit 15 for example registers, into the personnel/labor information DB 1A, the personnel/labor information related to human resources and labor of a worker such as information on clocking in/out of the worker acquired from the time recorder 21 and compiled by the compilation processing unit 14, and registers the labor asset information of the worker into the labor asset information DB 1B.

The reflection processing unit 16 executes processing that refers to the association information DB 1C in response to the update on one of the personnel/labor information and the labor asset information performed by the update processing unit 15, and reflects the update in another one of the labor asset information and the personnel/labor information associated with each other. As a result, the labor asset information constructing the personnel/labor information stored in the personnel/labor information DB 1A matches the labor asset information stored in the labor asset information DB 1B.

The edit accepting unit 17 accepts an edit of the labor asset information stored in the labor asset information DB 1B on the basis of an access from the worker terminal 3. Here, the labor asset information stored in the labor asset information DB 1B is adapted such that whether or not the edit can be performed is set for each predetermined item so that the edit accepting unit accepts an edit request for an item that can be edited but does not accept an edit request for an item that cannot be edited.

The history recording unit 18 records a history of the edit performed by a worker on the labor asset information stored in the labor asset information DB 1B. The edit history is displayed when the labor asset information is referenced so that one can grasp which information in the labor asset information is edited by the worker and which information is not edited. Note that when the information is edited, information before and after it is edited can both be kept as records.

The communication processing unit 19 is a functional unit that executes processing of transmitting/receiving various pieces of data to/from the time recorder 21, the in-house terminal 22 and the worker terminal 3 through the network NW.

The time recorder 21 is a device recording and managing clock-in and clock-out time of a worker. When the worker comes to work or leaves work, for example, the time recorder reads an IC card issued as biometric authentication or an employee ID card and records a clock-in time or a clock-out time. The clock-in and clock-out time are transmitted to the labor asset information management apparatus 1 through the network NW, compiled by the compilation processing unit 14, and stored as the definite personnel/labor information into the personnel/labor information DB 1A.

The terminal 22 is a terminal authenticated/managed by a company and can also be a so-called personal computer, smart phone, mobile phone, wearable terminal or the like. A function available on the in-house terminal 22 is limited depending on the authentication of a person having predetermined authority or the worker, where one can access information stored in the personnel/labor information DB 1A or the labor asset information DB 1B according to each authority level.

The worker terminal 3 is a terminal used by the worker and can also be a so-called personal computer or the like. The worker terminal 3 is used by the worker, who accesses the information stored in the labor asset information DB 1B while using the worker terminal 3.

Next, the flow of a series of processing performed by the labor asset information management apparatus 1 of the present embodiment will be described with reference to FIGS. 6 to 9.

The processing of associating the personnel/labor information and the labor asset information will be described first with reference to FIG. 6.

This processing is performed to utilize the labor asset information already stored in the labor asset information DB when a worker finds employment in a company, for example.

The setting processing unit 12 receives instruction information from an administrator or the like and sets association between the personnel/labor information and the labor asset information to be associated with each other (S101), so that the association information is stored in the association information DB 1C (S102).

According to the association information stored in the association information DB 1C, the registration processing unit 13 registers, into the personnel/labor information DB 1A, the labor asset information as information constructing the personnel/labor information with which the labor asset information is associated (S103).

As a result, the labor asset information and the personnel/labor information are associated with each other while the labor asset information is reflected in the personnel/labor information, whereby the company can utilize the labor asset information as one of the personnel/labor information.

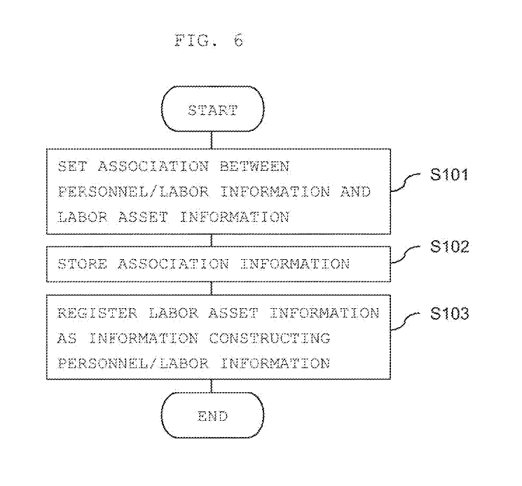

Next, there will be described processing performed when the personnel/labor information or the labor asset information is updated, with reference to FIGS. 7 and 8.

When raw data such as clock-in/out information of a worker is supplied from the in-house terminal 22 or the time recorder 21 (S201), as illustrated in FIG. 7, the labor asset information management apparatus 1 receives the uncompiled raw data and accumulates it into the uncompiled information DB 1D. The uncompiled information accumulated in the uncompiled information DB 1D is compiled by the compilation processing unit at an appropriate timing and made into the definite personnel/labor information (S202).

The personnel/labor information being a compiled result is updated and registered in the personnel/labor information DB 1A (S203). Note that information updated/registered in this manner also includes task start/end time, a report, an application, an approval, a task report, a training report, qualification acquisition information, a Web test, a Web questionnaire, information on an in-house SNS, attendance management, salary calculation, and a compiled result processed and compiled by a personnel evaluation system that are transmitted from the in-house terminal 22 or the worker terminal 3. The definite personnel/labor information other than the raw data may also be registered directly into the personnel/labor information DB 1A without being registered into the uncompiled information DB 1D.

In response, the reflection processing unit 16 of the labor asset information management apparatus 1 reflects update information registered in the personnel/labor information DB 1A in the labor asset information DB 1B as update information of the labor asset information stored in the labor asset information DB 1B at all times or at a predetermined timing (S204).

While the personnel/labor information of the company can be updated, the labor asset information of an individual worker can also be updated by executing similar processing as illustrated in FIG. 8 where, when new update information is registered in the labor asset information DB 1B, the new information is updated in the personnel/labor information DB 1A as well without delay. That is, when a worker edits or modifies the labor asset information accompanying a change in a part of his personal information due to marriage, childbirth and moving, for example, these new pieces of information are updated and registered in the labor asset information DB 1B (S211).

In response, the reflection processing unit 16 of the labor asset information management apparatus 1 reflects the update information registered in the labor asset information DB 1B in the personnel/labor information DB 1A as update information of the personnel/labor information stored in the personnel/labor information DB 1A at all times or at a predetermined timing (S212).

As a result of these processing, the labor asset information constructing the personnel/labor information stored in the personnel/labor information DB 1A matches the corresponding labor asset information of the individual worker stored in the labor asset information DB 1B. Therefore, when a worker signs up for various insurances eligible for tax deduction or to be recorded as a welfare expense and registers it as the labor asset information, for example, such information is automatically reflected in the personnel/labor information so that a company can properly perform personnel/labor management while grasping information on the insurance, such as automatically linking the information to tax deduction and welfare expense in an accounting system of the company and automatically assigning the information under an item corresponding to salary/benefit.

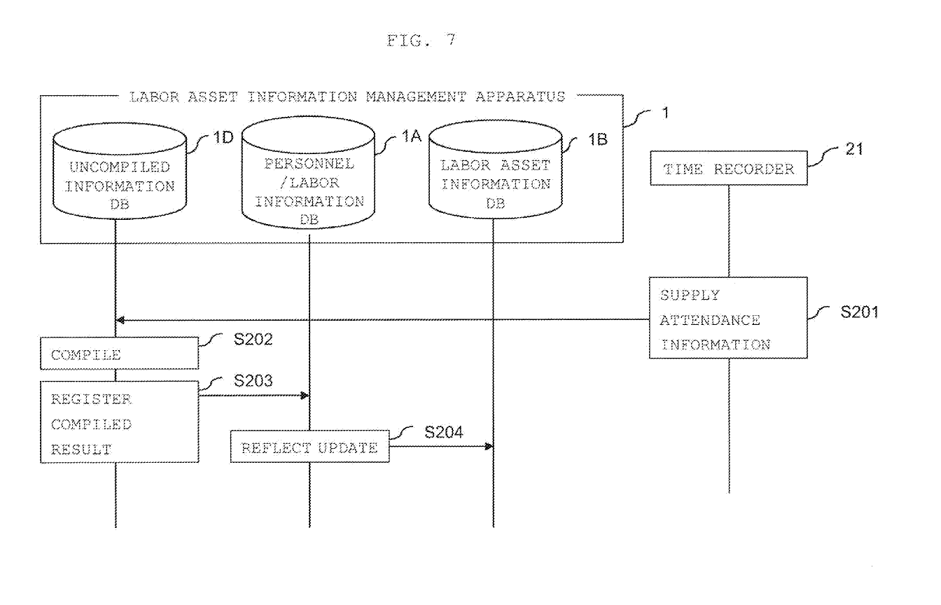

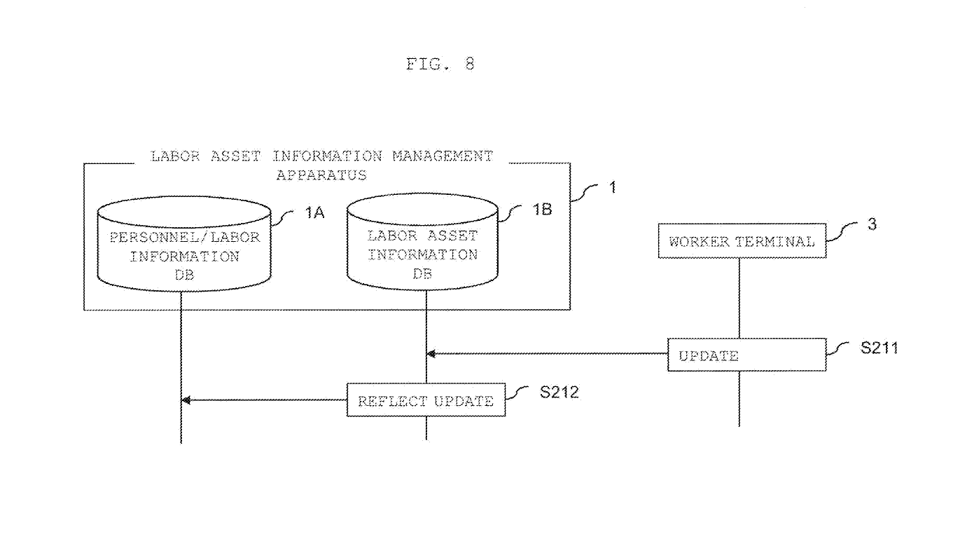

Next, there will be described processing performed when accepting an edit on the labor asset information stored in the labor asset information DB 1B from a worker, with reference to FIG. 9.

The worker uses the worker terminal 3 to access the labor asset information management apparatus 1 (S301) and goes through authentication processing to obtain access authorization by using predetermine ID and password (S302).

When the worker refers to the labor asset information stored in the labor asset information DB 1B and transmits an edit request for a predetermined item (S303), the edit accepting unit 17 determines whether or not the item for which the edit request is made can be edited by referring to the setting that specifies whether or not editing is allowed (S304).

When editing of the item for which the edit request is made is not allowed as a result of the determination, the processing ends upon returning a message to that effect to the worker terminal 3 (S305).

On the other hand, when editing of the item for which the edit request is made is allowed, the edited information accepted from the worker terminal 3 is updated and registered in the labor asset information DB 1B by the update processing unit 15 (S306).

The history recording unit 18 records an edit history of the editing into the labor asset information DB 1B (S307).

According to the present embodiment described above, the labor asset information unique to the worker in the personnel/labor information managed within the company is separated from the other information and managed separately, so that the worker can utilize the labor asset information while preventing important information within the company from being leaked out. In particular, when the worker resigns from the company or changes jobs, the labor asset information accumulated as apart of the personnel/labor information in the company can be utilized as material for objective evaluation. Moreover, a predetermined item or content in the labor asset information cannot be edited by the worker whereas the edit history is recorded for an item or content that can be edited, so that objectivity of the labor asset information can be guaranteed.

Next, a labor asset information management apparatus according to a second embodiment of the present invention will be described.

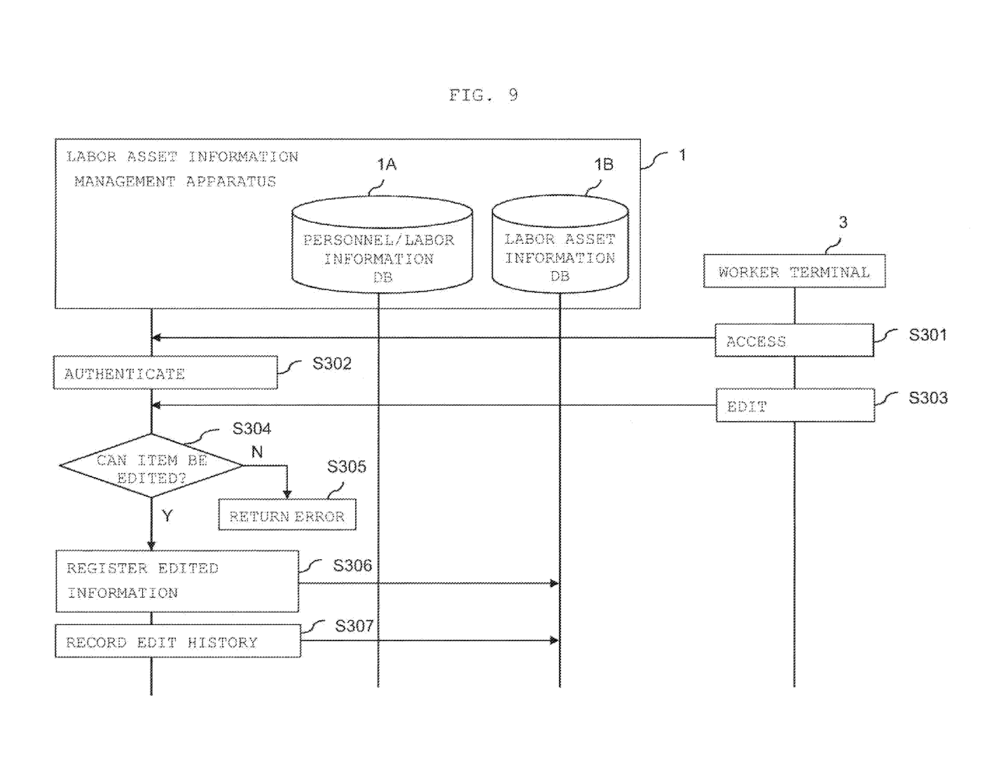

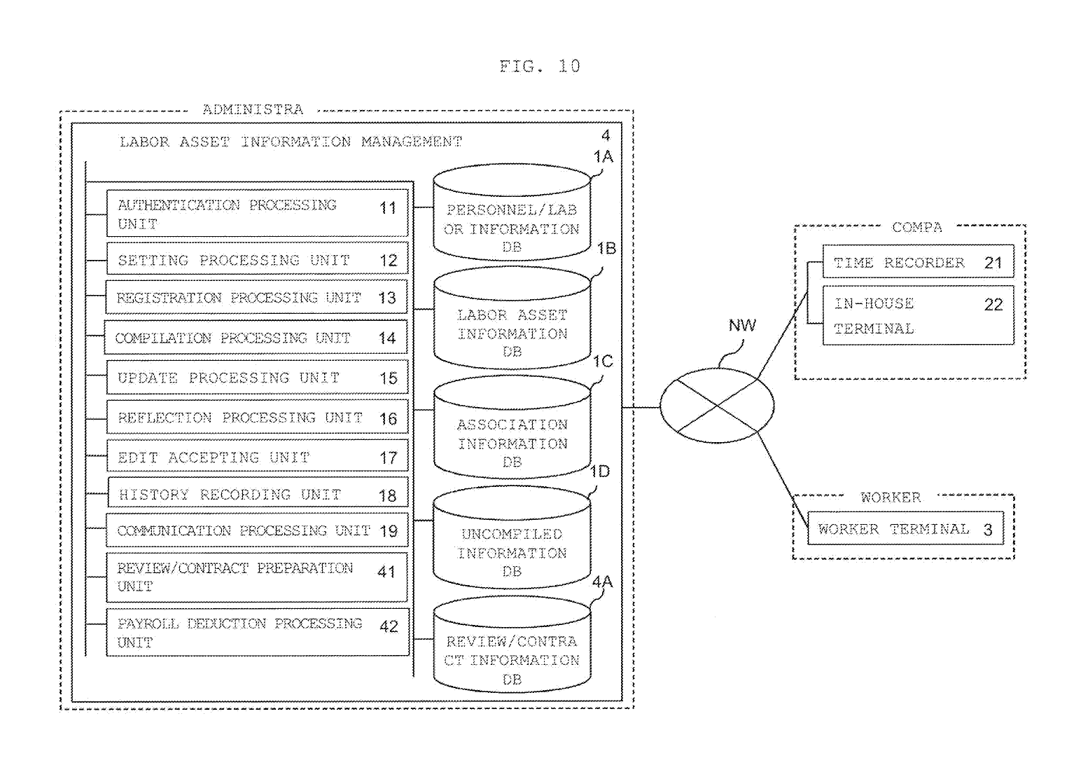

As illustrated in FIG. 10, a labor asset information management apparatus 4 of the present embodiment is adapted to be able to perform a review on a product requiring a contract (hereinafter referred to as a “contract-requiring product”) such as an insurance, a bank account, a credit card, and a loan corresponding to an individual worker as well as prepare a written contract of such product to be provided to the worker, where the labor asset information management apparatus is configured to be able to communicate with a time recorder 21, an in-house terminal 22, and a worker terminal 3 through a network NW.

Note that the time recorder 21, the in-house terminal 22 and the worker terminal 3 have the same configurations as the terminals described in the first embodiment.

The labor asset information management apparatus 4 manages personnel/labor information related to human resources and labor of the worker as well as labor asset information included in the personnel/labor information and unique to the worker, and is managed by an administrator of a third party different from the company or a worker working in accordance with the present embodiment.

The labor asset information management apparatus 4 is realized by a so-called server computer or the like and uses hardware resources including a CPU (Central Processing Unit), a RAM (Random Access Memory), a ROM (Read Only Memory) and a hard disk drive as well as a software resource including a computer program run by the CPU to configure a functional block including an authentication processing unit 11, a setting processing unit 12, a registration processing unit 13, a compilation processing unit 14, an update processing unit 15, a reflection processing unit 16, an edit accepting unit 17, a history recording unit 18, a communication processing unit 19, a personnel/labor information DB 1A, a labor asset information DB 1B, an association information DB 1C, and an uncompiled information DB 1D that are included in the labor asset information management apparatus 1 of the first embodiment as well as a review/contract processing unit 41, a payroll deduction processing unit 42 and a review/contract information DB 4A.

Note that the authentication processing unit 11, the setting processing unit 12, the registration processing unit 13, the compilation processing unit 14, the update processing unit 15, the reflection processing unit 16, the edit accepting unit 17, the history recording unit 18, the communication processing unit 19, the personnel/labor information DB 1A, the labor asset information DB 1B, the association information DB 1C, and the uncompiled information DB 1D have the same configurations as the functional units described in the first embodiment.

The review/contract information DB 4A is a storage that stores information on review criteria and content provided that are determined by an insurance company, a finance company, or a credit company providing each contract-requiring product as well as information on a contract that is actually closed, when the contract-requiring product such as an insurance, opening of a bank account, a credit card, or a loan is to be provided to a worker.

The review criteria and content provided correspond to the labor asset information of the worker and are adapted to be able to determine whether or not the product can be provided or determine the content provided on the basis of the labor asset information of the worker.

The review/contract processing unit 41 executes processing that collates the review/contract information stored in the review/contract information DB 4A with the labor asset information stored in the labor asset information DB 1B for a predetermined contract-requiring product for which the worker applies, and performs a review to determine whether or not the contract-requiring product can be provided to the worker, the information of whom is stored in the labor asset information, and determines content to be provided on the basis of an evaluation against a health condition and morale in the labor asset information. Moreover, when the worker approves closure of a contract of the predetermined contract-requiring product after review, the review/contract processing unit prepares a written contract on the basis of the content of the contract-requiring product proposed to the worker and the labor asset information of the worker.

The payroll deduction processing unit 42 executes processing that refers to the personnel/labor information DB 1A and deducts a predetermined premium or product price from the salary, whereby the salary of the worker is calculated. The payroll deduction processing unit 42 may further perform transfer processing that transfers the calculated salary of the worker into a bank account or the like of the worker on the basis of predetermined information such as a transfer account.

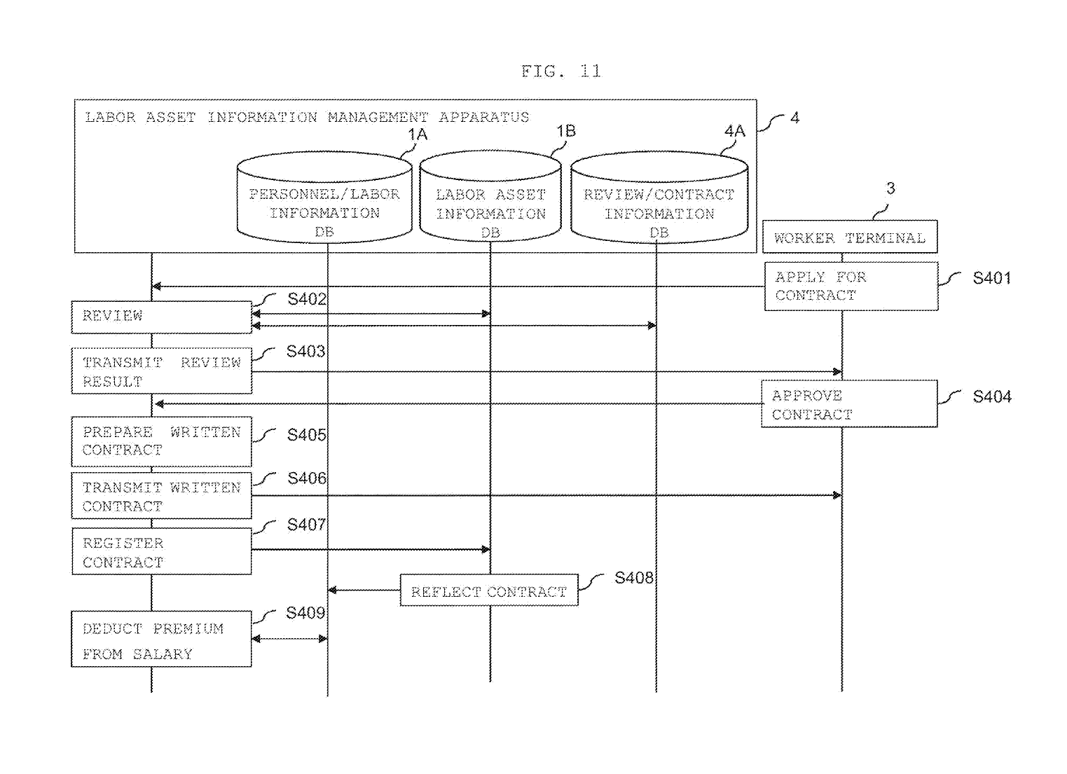

Next, there will be described the flow of processing performed until a contract-requiring product corresponding to a worker is provided to the worker, with reference to FIG. 11. Note that there will be described an example where the contract-requiring product is an insurance.

The worker transmits an application for an insurance policy from a predetermined web page provided for the worker (S401).

Once the labor asset information management apparatus 4 accepts the application for the insurance policy from the worker, the review/contract processing unit 41 executes a review on whether or not the corresponding product can be provided (S402).

This processing is performed on the basis of predetermined information in the labor asset information of the worker stored in the labor asset information DB 1B as well as the review/contract information stored in the review/contract information DB 4A. Specifically, the review/contract processing unit determines whether or not the product can be provided and determines content of the product such as a premium by scoring the labor asset information and determining whether the condition meets according to review/contract information specified by a company that provides the insurance for which the worker applies.

When a review result indicating whether the product for which the worker applies can be provided and indicating the content of the product is transmitted to the worker terminal 3 (S403), the worker at his will transmits a contract approval for the product (S404).

The contract is completed once the labor asset information management apparatus 4 receives the contract approval from the worker terminal 3, and then the review/contract processing unit 41 prepares a written contract based on the content of insurance proposed to the worker and the labor asset information of the worker (S405), and transmits the written contract to the worker terminal 3 (S406).

Moreover, the content of the approved insurance is updated and registered into the labor asset information DB 1B by the update processing unit 15 (S407). The insurance information updated and registered is then reflected in the personnel/labor information DB 1A by the reflection processing unit 16 on the basis of the association information (S408).

Once the insurance information is registered into the personnel/labor information DB 1A, the payroll deduction processing unit 42 executes processing that deducts a predetermined premium specified in the insurance information from the salary on the basis of the insurance information, when calculating the salary of the worker (S409).

Note that in proposing the contract-requiring product for which the worker applies, the present example may also be adapted to perform a review on the contract-requiring product by a plurality of companies capable of providing the contract-requiring product to then propose the review result and the product content in a list to the worker and provide the contract-requiring product selected by the worker at his will to the worker.

Moreover, a procedure or the like required to conclude or establish the contract is performed as appropriate by separately notifying one party of the contract such as the insurance company of the content of the contract actually signed up with the worker.

The present embodiment as described above is adapted to be able to determine whether or not the contract-requiring product can be provided and set the content provided in detail on the basis of the attendance information, the working hours and the salary record of the worker included in the labor asset information. Moreover, when the company bears a part or all costs related to a product or service eligible for income tax deduction that is opened, signed up for or contracted by the worker, the labor asset information management apparatus 4 can keep track of these information so that the load on the company performing an accounting task can be reduced drastically.

What is claimed is:

1. A labor asset information management apparatus that separately manages labor asset information unique to a worker among information constructing personnel/labor information related to human resources and labor of a worker, the apparatus comprising:
a personnel/labor information storage unit that stores the personnel/labor information;
a labor asset information storage unit that stores the labor asset information;
a setting processing unit that sets association between the personnel/labor information and the labor asset information;
an association information storage unit that stores association information between the personnel/labor information and the labor asset information;
a registration processing unit that registers, into the personnel/labor information storage unit, the labor asset information as information constructing the personnel/labor information with which the labor asset information is associated according to the association information;
an update processing unit that updates and registers update information on the personnel/labor information or the labor asset information by referring to the personnel/labor information storage unit or the labor asset information storage unit; and
a reflection processing unit that reflects an update of one of the personnel/labor information and the labor asset information in another one of the labor asset information and the personnel/labor information associated with each other by referring to the association information storage unit.

2. The labor asset information management apparatus according to claim 1, wherein
the apparatus is configured to be able to communicate with a worker terminal used by the worker through a network, and further comprises an authentication processing unit that authenticates an access to the labor asset information storage unit storing the labor asset information from the worker terminal, on the basis of unique authentication information issued to a worker holding the labor asset information.

3. The labor asset information management apparatus according to claim 2, further comprising
an edit accepting unit that accepts, from the worker terminal, an edit on the labor asset information stored in the labor asset information storage unit.

4. The labor asset information management apparatus according to claim 3, wherein
editing of predetermined information by the worker is restricted, the predetermined information being included in the labor asset information stored in the labor asset information storage unit.

5. The labor asset information management apparatus according to claim 3, further comprising
a history recording unit that records a history of an edit performed by the worker on the labor asset information stored in the labor asset information storage unit.

6. The labor asset information management apparatus according to claim 2, further comprising:
a review/contract information storage unit that stores review criteria corresponding to the labor asset information for a contract-requiring product;
a review processing unit that, on the basis of an application for a predetermined contract-requiring product by the worker, performs a review pertaining to whether or not the predetermined contract-requiring product can be provided by referring to the labor asset information and the review/contract information storage unit; and
a contract approval reception unit that receives from the worker terminal a contract approval based on a result of the review with regard to the predetermined contract-requiring product, wherein
the update processing unit refers to the labor asset information storage unit to update and register information on the contract-requiring product, a contract of which is completed by the contract approval, as a piece of information constructing the labor asset information.

7. The labor asset information management apparatus according to claim 6, wherein
the predetermined contract-requiring product is an insurance for which a predetermined premium is determined, and
the labor asset information management apparatus further comprises a payroll deduction processing unit that executes processing of referring to the personnel/labor information storage unit in which information on an insurance updated and registered in the labor asset information storage unit is reflected and deducting the premium from a salary of the worker according to content of the insurance.

8. A labor asset information management method that separately manages labor asset information unique to a worker as labor asset information among information constructing personnel/labor information related to human resources and labor of a worker, the method causing a computer to execute:
processing of setting association between the personnel/labor information and the labor asset information;
processing of registering, into a personnel/labor information storage unit, the labor asset information as labor asset information constructing the personnel/labor information with which the labor asset information is associated according to association information;
processing of updating and registering update information on the personnel/labor information or the labor asset information by referring to the personnel/labor information storage unit or a labor asset information storage unit; and
processing of reflecting an update of one of the personnel/labor information and the labor asset information in another one of the labor asset information and the personnel/labor information associated with each other by referring to an association information storage unit,
the computer including:
the personnel/labor information storage unit that stores the personnel/labor information;
the labor asset information storage unit that stores the labor asset information; and
the association information storage unit that stores the association information between the personnel/labor information and the labor asset information.

9. A computer program that separately manages labor asset information unique to a worker as labor asset information among information constructing personnel/labor information related to human resources and labor of a worker, the program causing a computer to execute:
processing of setting association between the personnel/labor information and the labor asset information;
processing of registering, into a personnel/labor information storage unit, the labor asset information as labor asset information constructing the personnel/labor information with which the labor asset information is associated according to association information;
processing of updating and registering update information on the personnel/labor information or the labor asset information by referring to the personnel/labor information storage unit or a labor asset information storage unit; and
processing of reflecting an update of one of the personnel/labor information and the labor asset information in another one of the labor asset information and the personnel/labor information associated with each other by referring to an association information storage unit,
the computer including:
the personnel/labor information storage unit that stores the personnel/labor information;
the labor asset information storage unit that stores the labor asset information; and
the association information storage unit that stores the association information between the personnel/labor information and the labor asset information.
